(19) United States
(12) Patent Application Publication
(10) Pub. No.: US 2009/0150242 A1
(43) Pub. Date: Jun. 11, 2009

(54) System for displaying advertisements on vehicles

(76) Inventor: Kenneth J. Del Cogliano, Foley, AL (US)

Correspondence Address: WILLIAM J. MASON;MACCORD MASON PLLC, POST OFFICE BOX 1489, WRIGHTSVILLE BEACH, NC, 28480, US

(21) Appl. No.: 12/315,410

(22) Filed: Dec. 3, 2008

Related U.S. Application Data
(60) Provisional application No. 61/005,643, filed on Dec. 6, 2007.

(51) Int. Cl. G06Q 30/00; B60Q 1/00

(52) U.S. Cl. 705/14; 340/425.5

(57) ABSTRACT

A method and system are provided for displaying selected advertisements on a vehicle for external viewing with the advertisements being selected based on the location and direction of movement of the vehicle when moving along a highway having a plurality of exits defined by exit zones, the exit zones being separated by non-exit zones, which includes the steps and related components for determining the position and direction of movement of the vehicle; storing exit coordinates and local advertisements of local advertisers; and displaying at least one stored local advertisement of at least one local advertiser located at a given exit when the vehicle is in a given exit zone. Non-exit specific advertisements may be displayed when local advertisements are not displayed.

This application claims the benefit of the filing date of U.S. Provisional Patent Application No. 61/005,643, filed Dec. 6, 2007.

### BACKGROUND OF THE INVENTION

(1) Field of the Invention

The present invention relates generally to a system for displaying selected advertisements on a vehicle for external viewing, with the advertisements being selected based on the location and direction of movement of the vehicle; and in particular to a system of this nature which displays advertisements of advertisers located at highway exits as the vehicle approaches the exit and displays advertisements of non-location specific advertisers when advertisements of local advertisers are not displayed.

(2) Description of the Prior Art

Display signs on the exterior of moving vehicles are commonly used to convey advertising messages to individuals external to the vehicle. While normally having a fixed message, these signs can also be designed to display multiple advertisements in sequence.

Recently, it has been proposed to use vehicle mounted electronic displays connected to a processor and a source of advertisements to display selected advertisements based on the location of the vehicle. Examples of prior art describing these systems are U.S. Pat. No. 6,060,993 to Cohen; U.S. Pat. No. 6,898,517 to Froeberg; and U.S. Pat. No. 7,154,383 to Berquist. While these patents describe the general concept of displaying electronic advertising based on vehicle location, normally determined by GPS coordinates, they do not provide for an optimal system or method for providing vehicle-mounted advertising for local advertisers at exits along a highway or for utilization of the system for additional advertising when the vehicle is not proximate to an exit of a local advertiser.

### SUMMARY OF THE INVENTION

The present invention addresses these deficiencies of the prior art by providing a system for displaying advertising on a vehicle moving along a highway having a plurality of exits defined by exit zones, the exit zones being separated by non-exit zones. As used herein, an “exit zone” is a section of highway extending for a predetermined distance on the approach side of an exit, with the term “non-exit zone” defining the section of a highway between exit zones.

The system is generally comprised of a) an electronic display means mountable on a vehicle for external display; b) a global positioning system for determining the position and direction of movement of the vehicle; c) storage means to store exit coordinates and local advertisements by local advertisers; and d) a processing means in communication with the display means, the global positioning system and the storage means for causing at least one stored local advertisement of at least one local advertiser located at a given exit to be displayed on the display means when the vehicle is in a given exit zone.

In addition, the system may store advertisements by non-exit specific advertisers so that the processing means causes at least one of these non-exit specific advertisements to be displayed when local advertisements are not displayed. For example, the non-exit specific advertisements may be displayed when the vehicle is between exit zones or within an exit zone that does not have a local advertiser whose advertisement is to be displayed.

As used herein, the term “vehicle” means any motorized vehicle capable of use on highways, e.g., automobiles, trucks, trailer-trucks, etc. The vehicle may be used for purposes in addition to the display of advertising, e.g., the transport of goods or people, or may be designed solely for the purpose of displaying advertising to occupants of other vehicles in the vicinity.

The electronic display means may be a liquid crystal display (LCD) screen, a cathode ray tube (CRT), a thin film transistor (TFT) display, a plasma display, or other type of display screen capable of receiving an electronic input and displaying a graphic or alphanumeric image determined by the electronic input. The display can be located on any part of the vehicle where it is visible to individuals external to the vehicle. For example, the display may be located on the side or back of the vehicle. More than one display may be used, and the display can be programmed for a split screen to display a plurality of advertisements or other information.

The geographic location means may be any means that can be used to determine the geographic position, i.e., the latitude and longitude of the vehicle. The preferred geographic location means is a Global Positioning System (GPS) which determines its position, and thereby the position of the vehicle in which it is mounted, from satellite signals.

The storage means may be any type of storage means commonly used to store electronic data, e.g., a hard drive, rewriteable CD-ROM, a flash memory, or other magnetic or magneto-optical memory device. It will be understood that the term “storage means” can refer to a single storage means or to a plurality of storage means that store different types of data. For example, one storage means can store information relating to the identity and location of advertisers, while a second storage means can store advertisements in electronic form.

The processing means may be any form of electronic processor capable of performing the steps required by the present invention required to display selected images on the display screen. For example, the processing means may be a general purpose computer, an Internet server, a microprocessor, or a controller. In general, the processing means should be capable of receiving geographic location information from a moving vehicle, comparing the geographic location information with the geographic locations of highway exits corresponding to local advertisers, determining which stored advertisements should be displayed by the vehicle and the time when the advertisements are to be displayed, and sending commands to display the selected advertisements on the display means at the determined time.

In addition, the processing means should be capable of determining when the moving vehicle is outside of a zone where local advertising is to be displayed and sending commands to display selected advertisements for non-exit specific advertisers, i.e., advertisers that are not associated with a given highway exit. For example, non-exit specific advertisers may be national advertisers whose messages have national relevance, such as Coca-Cola or McDonalds.

All of the components of the present system may be located on the vehicle which is to display the advertisements. However, this configuration requires access to each vehicle to update advertiser data, add new advertisements to storage, etc. This can be time consuming and difficult if multiple vehicles are involved, especially since the vehicles may change locations frequently and may be located in different parts of the country.

In order to facilitate rapid updating of multiple vehicles and to ensure that the correct advertisements are displayed at the proper times, one or more components of the system can be positioned remotely from the vehicle or vehicles with the components being remotely connected by wireless communication means. For example, the processor and storage means can be located at a remote site, with a common storage means and processor being in communication with multiple vehicles.

In this embodiment, a remote storage means can be periodically updated with the exit coordinates of local advertisers, and with current advertisements. A remote processor can wirelessly receive data relating to the geographic location of one or more vehicles. The remote processor can then compare a vehicle's location, and the direction and speed of movement of the vehicle as calculated from multiple data inputs, against a stored database of advertiser locations.

The processor can then wirelessly transmit relevant advertisements and instructions to a receiver on the vehicle, which may be another processor, instructing the vehicle components of the system to display the transmitted advertisements when the vehicle reaches the exit zone corresponding to the advertiser's location. In addition, when the geographic positioning information indicates that the vehicle is not entering an exit zone, the remote processor can transmit non-zone specific advertisements with instructions to the on-vehicle system components to display the non-zone specific advertisements when the vehicle in outside of an active exit zone, i.e., an exit zone with a current local advertiser.

It will be apparent from reading of the present specification that other configurations of the system are also possible. For example, the advertisements can be stored in a storage means on the vehicle with the processor only transmitting instructions to display selected advertisements. The stored advertisements can then be periodically updated either by a hardwired connection to the storage means or by a separate wireless update.

In one embodiment of a wireless system, the processing means can be an Internet server and the storage means can be the Internet hard drive, with the processing means being in communication with the on-vehicle components of the system via an Internet broadband connection. With this configuration, the server processor can also include software enabling a customer to subscribe to the service online by entering their address, which can be converted to GPS coordinates by the software, and uploading their advertisements to the server's storage means. Software can also be included to record the number of times that an advertisement is displayed and to bill the advertiser, or debit the advertiser's credit card.

Thus, in operation, advertisements of local advertisers and the geographic locations of the highway exits near the local advertisers' locations are stored in a database. The geographic coordinates, direction and speed of advertising vehicles are determined. When an advertising vehicle enters the exit zone of a local advertiser, the local advertisement is displayed until the vehicle departs the exit zone. Optionally, a non-exit specific advertisement may then be displayed until the vehicle enters another exit zone.

In a specific application, information is acquired via an Internet website regarding local advertisers who desire to participate in the advertising program. The local advertiser provides, via the website GUI, the advertiser's geographic coordinates, and uploads the local advertisement to be displayed. The advertiser may also input credit card information, length of time or number of times the advertisement is to be run, and other relevant information.

Each participating vehicle can then periodically or continually transmit vehicle coordinates via the Internet to the server. Software on the processor then determines when a given vehicle is approaching an exit zone corresponding to the location of an advertiser, and transmits the appropriate stored advertisement to the vehicle with instructions to display the advertisement while the vehicle is in the exit zone. Provision can also be made to allow the advertiser to determine how often and when its advertisements have been displayed in order to monitor the effectiveness of the advertisement, e.g., by any corresponding increase in business.

### BRIEF DESCRIPTION OF THE DRAWINGS

FIG. 1 is a rearview of a vehicle with a mounted display screen.

FIG. 2 is a schematic of an on-vehicle system.

FIG. 3 is a schematic of a system in which the processor and storage are remote from the vehicle and connected via the Internet.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

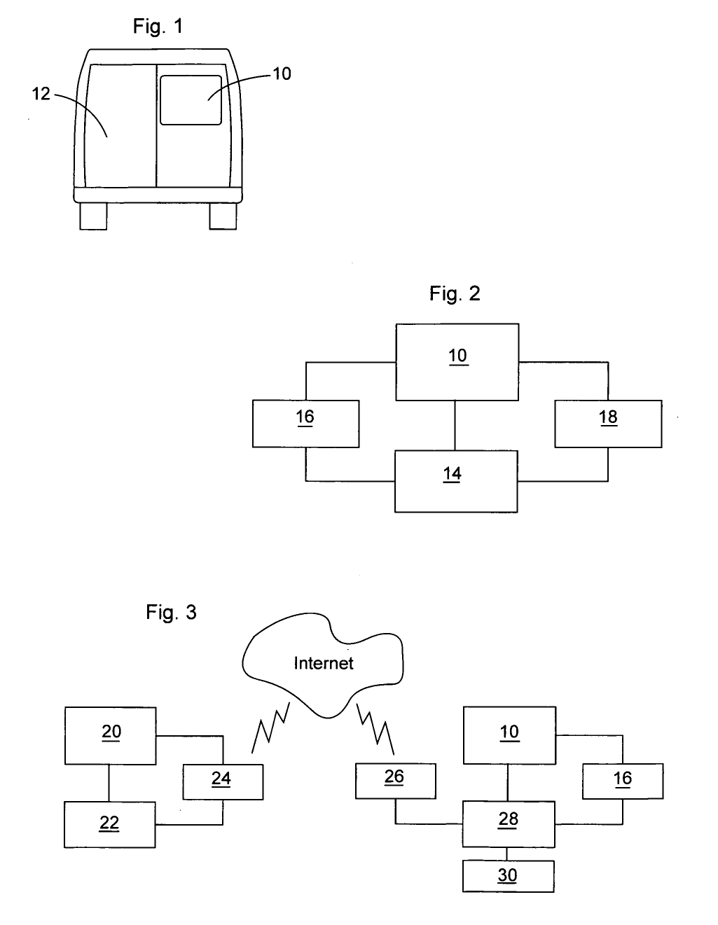

As illustrated in FIG. 1, a display screen 10 is mounted on the back of a vehicle 12. It will be understood that the type of vehicle shown is only for purposes of illustration and that any motorized vehicle for highway use is suitable. In addition, screen 10 can be located on other areas of vehicle 10, such as a side panel.

As illustrated in FIG. 2, a typical system fully on the vehicle may be comprised of display screen 10 in wired communication with processor 14, GPS 16 and storage means 18. In use, processor 14, receives location information from GPS 16 to determine the location and direction of movement of vehicle 10. Processor 14, using stored information in storage means 18, then determines the position of vehicle 10 relative to highway exits where advertisers are located. As vehicle 10 enters a zone where an exit with an advertiser is located, processor 10 commands screen 10 to display a selected advertisement from storage means 18. Processor 14 can also command screen 10 to display non-exit specific advertisements at other times.

FIG. 3 illustrates an embodiment of the system in which the primary processor 20 and storage 22 are located at a remote site, illustrated as an Internet server, which is designed to communicate via modem 24 and the Internet with the on-vehicle components of the system, namely, a second modem 26 to receive and send data to and from modem 24, a second processor 28, a storage means 30, GPS 16, and display screen 10.

In operation, GPS 16 determines the longitude and latitude of vehicle 10 and sends the coordinates to processor 28 which transmits the coordinates via modem 26 and the Internet to modem 24 which transfers the coordinates to processor 20. Processor 20 then determines the location and direction of movement of vehicle 10 relative to exit zones where subscribing advertisers are located using advertiser data in storage 22.

Processor 20 then transmits instructions to processor 26 to command display screen 10 to display selected advertisements as vehicle 10 enters the relevant exit zones. In addition, processor 20 may instruct processor 26 to command display screen 10 to display advertisements of non-exit specific advertisers at other times. The advertisements to be displayed may be transmitted via broadband from storage 22, or drawn from on-vehicle storage 30, which can be periodically updated via the wireless link.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A system for displaying selected advertisements on a vehicle for external viewing with the advertisements being selected based on the location and direction of movement of the vehicle when moving along a highway having a plurality of exits defined by exit zones, the exit zones being separated by non-exit zones comprising:
a) an electronic display means mountable on a vehicle for external display;
b) a geographic location means for determining the position and direction of movement of the vehicle;
c) storage means to store exit coordinates and local advertisements by local advertisers; and
d) a processing means in communication with the display means, the global positioning system and the storage means for causing at least one stored local advertisement of at least one local advertiser located at a given exit to be displayed on the display means when the vehicle is in a given exit zone.

2. The system of claim 1, wherein said storage means also stores advertisements by non-exit specific advertisers, said processing means causing at least one of these non-exit specific advertisements to be displayed when local advertisements are not displayed.

3. The system of claim 1, wherein said electronic display means is a liquid crystal display (LCD) screen, a cathode ray tube (CRT), a thin film transistor (TFT) display, or a plasma display.

4. The system of claim 1, wherein said geographic location means is a Global Positioning System (GPS).

5. The system of claim 1, wherein said storage means is a hard drive, a rewriteable CD-ROM, or a flash memory.

6. The system of claim 1, wherein the processing means is capable of receiving geographic location information from a moving vehicle, comparing the geographic location information with the geographic locations of highway exits corresponding to local advertisers, determining which stored advertisements should be displayed by the vehicle and the time when the advertisements are to be displayed, and sending commands to display the selected advertisements on the display means at the determined time.

7. The system of claim 1, wherein the processing means is capable of determining when the moving vehicle is outside of a zone where local advertising is to be displayed and sending commands to display selected advertisements for non-exit specific advertisers.

8. The system of claim 1, wherein at least one of the system components is located remotely from the vehicle with the other system components being located on the vehicle, said remotely located components being connected by wireless communication means with said on-vehicle components.

9. The system of claim 8, wherein said remotely located components include a remote storage means that can be periodically updated with coordinates of local advertisers and their current advertisers, a remote processor to wirelessly receive data relating to the geographic location of at least one vehicle and compare the vehicle's location against stored advertiser information, and transmit relevant advertisements to a receiver on the vehicle for display when the vehicle reaches the advertiser's location.

10. The system of claim 9, wherein said processing means is an Internet server.

11. The system of claim 9, wherein said remote processing means includes means to enable customers to subscribe, enter their geographic location, and upload their advertisements.

12. A system for displaying exit specific and non-exit specific advertisements on a vehicle for external viewing with the advertisements being selected based on the location and direction of movement of the vehicle when moving along a highway having a plurality of exits defined by exit zones, the exit zones being separated by non-exit zones comprising:
a) an electronic display means mountable on a vehicle for external display;
b) a geographic location means for determining the position and direction of movement of the vehicle;
c) storage means to store exit coordinates and local advertisements by local advertisers; and
d) a processing means in communication with the display means, the global positioning system and the storage means for causing at least one stored local advertisement of at least one local advertiser located at a given exit to be displayed on the display means when the vehicle is in a given exit zone and for causing non-exit specific advertisements to be displayed when local advertisements are not displayed.

13. The system of claim 12, wherein the processing means is capable of receiving geographic location information from a moving vehicle, comparing the geographic location information with the geographic locations of highway exits corresponding to local advertisers, determining which stored advertisements should be displayed by the vehicle and the time when the advertisements are to be displayed, and sending commands to display the selected advertisements on the display means at the determined time.

14. A method for displaying selected advertisements on a vehicle for external viewing with the advertisements being selected based on the location and direction of movement of the vehicle when moving along a highway having a plurality of exits defined by exit zones, the exit zones being separated by non-exit zones comprising:
a) determining the position and direction of movement of the vehicle;
b) storing exit coordinates and local advertisements of local advertisers; and
c) displaying at least one stored local advertisement of at least one local advertiser located at a given exit when the vehicle is in a given exit zone.

15. The method of claim 14, further including displaying non-exit specific advertisements when local advertisements are not displayed.

16. The method of claim 14, including receiving geographic location information from a moving vehicle, comparing the geographic location information with the geographic locations of highway exits corresponding to local advertisers, determining which stored advertisements should be displayed by the vehicle and the time when the advertisements are to be displayed, and sending commands to display the selected advertisements at the determined time.

17. The method of claim 14, including determining when the moving vehicle is outside of a zone where local advertising is to be displayed and sending commands to display selected advertisements for non-exit specific advertisers.

18. The method of claim 14, including providing means to enable customers to subscribe, enter their geographic location, and upload their advertisements.

19. The method of claim 14, wherein said advertisement is displayed in response to commands received by wireless communication.

20. The method of claim 18, where said communication is via the Internet.
